(19) United States
(12) Patent Application Publication
(10) Pub. No.: US 2015/0362029 A1
(43) Pub. Date: Dec. 17, 2015

(54) Carbon Article Having an Improved Anti-Oxidant Coating

(71) Applicant: Meggitt Aerospace Limited, Coventry (GB)

(72) Inventors: Craig Edwards, Berkswell (GB); David Callum Johnson, Warwickshire (GB); Andrew Sketchley, Nuneaton (GB)

(21) Appl. No.: 14/734,751

(22) Filed: Jun. 9, 2015

(30) Foreign Application Priority Data
Jun. 13, 2014 (GB) 1410549.8

(51) Int. Cl. F16D 65/12; C09D 7/12

(52) U.S. Cl. CPC F16D 65/127; F16D 65/126; C09D 7/1216

(57) ABSTRACT

A carbon article shaped as a brake disc, the brake disc being coated with an anti-oxidant coating obtained by applying as a primer coat a composition including orthophosphoric acid, aluminum chloride hydrated, a surfactant, industrial methylated spirits, and demineralized water; curing the primer coat; applying as a barrier coat a composition including orthophosphoric acid, aluminum chloride hydrated, a surfactant, industrial methylated spirits, demineralized water, colloidal silica, and boron nitride; and curing the barrier coat.

### FIELD OF THE INVENTION

An aspect of the present invention relates to a carbon article, such as a brake disc, having an anti-oxidant coating. Another aspect of the present invention relates to a carbon anti-oxidant system. Another aspect of the present invention further relates to a primer coat composition. Another aspect of the present invention relates to a carbon anti-oxidant system with a primer coat comprising orthophosphoric acid, aluminum chloride hydrated, a surfactant, industrial methylated spirits, and demineralized water and a barrier coat comprising orthophosphoric acid, aluminum chloride hydrated, a surfactant, industrial methylated spirits, demineralized water, colloidal silica, and boron nitride.

### BACKGROUND OF THE INVENTION

One issue with aircraft brake discs made from carbon is that they are prone to suffering from oxidation based on their operating environments. One attempt to protect these brake discs from oxidation involves the use of an anti-oxidant system. Anti-oxidant systems are utilized in brake discs to inhibit both catalytic oxidation and thermal oxidation.

Known anti-oxidant systems include compositions of varying components. These anti-oxidant systems have weaknesses of not addressing the issue of catalytic induced oxidation from runway deicers. The industry is ceasing to use urea deicers for environmental concerns. Instead, potassium and sodium based products are now being utilized. However, both are prone to result in catalytic oxidation of carbon brakes.

Oxidation has a negative effect on brake disc strength. In some cases, the disc may weaken to a point where it is no longer able to transfer torque, resulting in drive tenon failure. Oxidation includes both thermal oxidation and catalytic oxidation.

Thermal oxidation is experienced less frequently, but occurs due to high brake temperatures. Catalytic oxidation occurs due to the combination of chemical contamination and heat. Catalytic oxidation can occur because of cleaning fluid contamination. It has occurred more frequently after the introduction of the new generation runway deicing fluids (RDF's) based on alkali metals, acetate, and formates. Operators with route structures, where the brakes come into contact with these chemicals, experience more occurrences of catalytic oxidation. The effects of oxidation are not always immediately apparent, as the disc must be subject to elevated temperature for a certain time in order for the oxidation to fully develop.

There are growing concerns across the industry regarding the effect of RDF's on carbon brakes, particularly with respect to oxidation. The EASA and FAA have informed operators about the effects of oxidation and have suggested that carbon brake discs be inspected for signs of oxidation.

Thus, a need in the art exists for an improved carbon anti-oxidant coating for application on a carbon brake disc. An aspect of the present invention advances the art by providing an anti-oxidant coating and a carbon brake disc having an anti-oxidant coating that offer improved properties. Another aspect of the present invention also provides an improved primer coat composition.

### SUMMARY OF THE INVENTION

In a first embodiment, the present invention provides a carbon article formed as a brake disc, the brake disc being coated with an anti-oxidant coating, the anti-oxidant coating, as applied, comprising aluminum phosphate, wherein the aluminum phosphate is formed by reacting orthophosphoric acid with aluminum chloride hydrated; a surfactant, industrial methylated spirits, and demineralized water; and colloidal silica, and boron nitride.

In a second embodiment, the present invention provides a carbon article as in the first embodiment, wherein the anti-oxidant coating comprises aluminum phosphate in an amount from 5% to 25%.

In a third embodiment, the present invention provides a carbon article as in either the first or second embodiments, wherein the anti-oxidant coating comprises the surfactant in an amount from 0.01% to 0.1%, industrial methylated spirits in an amount from 10% to 30%, and demineralized water in an amount from 15% to 35%.

In a fourth embodiment, the present invention provides a carbon article as in any of the first through third embodiments, wherein the anti-oxidant coating comprises colloidal silica in an amount from 10% to 25% and boron nitride in an amount from 0.01% to 25%.

In a fifth embodiment, the present invention provides a carbon article as in any of the first through fourth embodiments, wherein the anti-oxidant coating further comprises boron.

In a sixth embodiment, the present invention provides a carbon article shaped as a brake disc, the brake disc being coated with an anti-oxidant coating obtained by applying as a primer coat a composition comprising orthophosphoric acid, aluminum chloride hydrated, a surfactant, industrial methylated spirits, and demineralized water; curing the primer coat; applying as a barrier coat a composition comprising orthophosphoric acid, aluminum chloride hydrated, a surfactant, industrial methylated spirits, demineralized water, colloidal silica, and boron nitride; and curing the barrier coat.

In a seventh embodiment, the present invention provides a carbon article as in the first sixth embodiment, wherein the pre-cured primer coat comprises orthophosphoric acid in an amount from 15% to 45%, aluminum chloride hydrated in an amount from 15% to 35%, a surfactant in an amount from 0.01% to 0.1%, industrial methylated spirits in an amount from 12% to 30%, and demineralized water in an amount from 15% to 35%.

In an eighth embodiment, the present invention provides a carbon article as in either the sixth or seventh embodiments, wherein the pre-cured barrier coat comprises orthophosphoric acid in an amount from 8% to 30%, aluminum chloride hydrated in an amount from 8% to 20%, a surfactant in an amount from 0.01% to 0.1%, industrial methylated spirits in an amount from 5% to 20%, demineralized water in an amount from 9% to 20%, colloidal silica in an amount from 10% to 25%, and boron nitride in an amount from 5% to 25%.

In a ninth embodiment, the present invention provides a carbon article as in any of the sixth through eighth embodiments, wherein the pre-cured barrier coat further comprises boron.

In a tenth embodiment, the present invention provides a carbon anti-oxidant system, as applied, comprising a primer coat composition comprising orthophosphoric acid, aluminum chloride hydrated, a surfactant, industrial methylated spirits, and demineralized water; and a barrier coat composition comprising orthophosphoric acid, aluminum chloride hydrated, a surfactant, industrial methylated spirits, demineralized water, colloidal silica, and boron nitride.

In an eleventh embodiment, the present invention provides a carbon anti-oxidant system as in the first tenth embodiment, wherein a primer coat comprises orthophosphoric acid in an amount from 15% to 45%, aluminum chloride hydrated in an amount from 15% to 35%, a surfactant in an amount from 0.01% to 0.1%, industrial methylated spirits in an amount from 12% to 30%, and demineralized water in an amount from 15% to 35%.

In a twelfth embodiment, the present invention provides a carbon anti-oxidant system as in either the tenth or eleventh embodiments, wherein the barrier coat comprises orthophosphoric acid in an amount from 8% to 30%, aluminum chloride hydrated in an amount from 8% to 20%, a surfactant in an amount from 0.01% to 0.1%, industrial methylated spirits in an amount from 5% to 20%, demineralized water in an amount from 9% to 20%, colloidal silica in an amount from 10% to 25%, and boron nitride in an amount from 5% to 25%.

In a thirteenth embodiment, the present invention provides a carbon anti-oxidant system as in any of the tenth through twelfth embodiments, wherein the primer coat further comprises boron.

In a fourteenth embodiment, the present invention provides a primer coat composition, comprising orthophosphoric acid, aluminum chloride hydrated, a surfactant, industrial methylated spirits, and demineralized water.

In a fifteenth embodiment, the present invention provides a primer coat composition as in the fourteenth embodiment, wherein a primer coat comprises orthophosphoric acid in an amount from 15% to 45% and aluminum chloride hydrated in an amount from 15% to 35%.

In a sixteenth embodiment, the present invention provides a primer coat composition as in either the fourteenth or fifteenth embodiments, wherein a primer coat comprises the surfactant in an amount from 0.01% to 0.1%, industrial methylated spirits in an amount from 12% to 30%, and demineralized water in an amount from 15% to 35%.

In a seventeenth embodiment, the present invention provides a primer coat composition as in any of the fourteenth through sixteenth embodiments, wherein the primer coat further comprises boron.

### BRIEF DESCRIPTION OF THE DRAWINGS

Advantages of the present invention will become better understood with regard to the following description, appended claims, and accompanying drawings wherein:

FIG. 1 is a top plan view of a brake disc made according to the invention; and

FIG. 2 is a cross-sectional view of the brake disc of FIG. 1, taken along the line 2-2.

### DETAILED DESCRIPTION OF ILLUSTRATIVE EMBODIMENTS

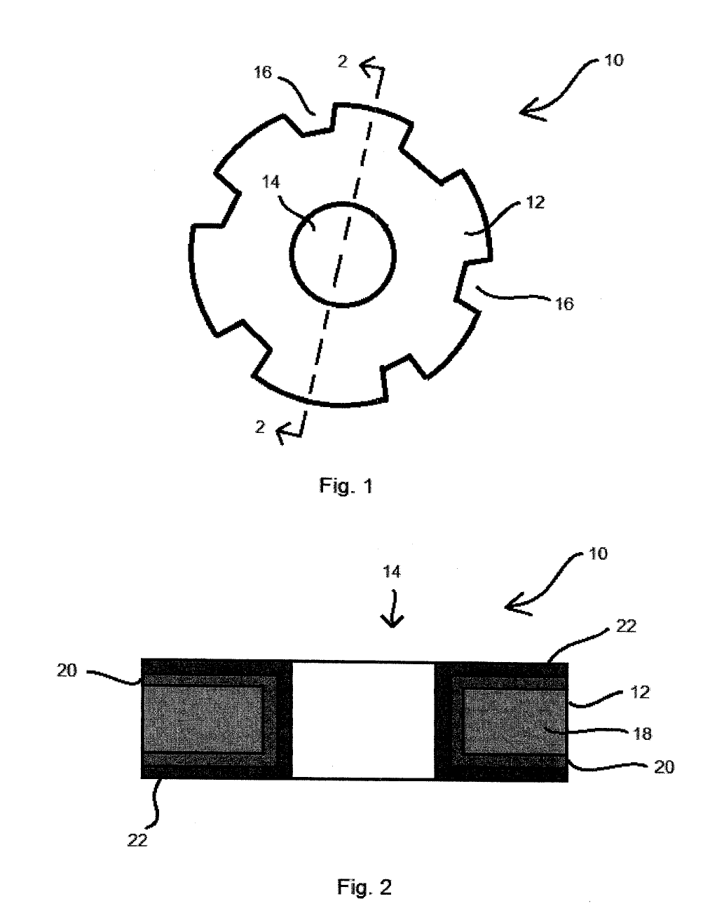

With reference now to FIG. 1 of the drawings, it can be seen that a carbon article, such as an aircraft brake disc, is designated generally by the numeral 10. Although a rotor disc is shown, the invention also applies to stator discs, as well as a host of other carbon products. The rotor disc 10 has a body 12 with a central annulus 14 for receiving a wheel axle. Keyways 16 are provided about the periphery for operative engagement with an aircraft wheel.

In FIG. 2, there is provided a cross-sectional view of the disc of FIG. 1, showing the basic elements of the invention described below. The body has a carbon base 18 that is coated with an anti-oxidant coating having a primer coat 20 adhered directly to the carbon, and a barrier coat 22 bonded to the primer coat 20.

An embodiment of the present invention relates to a carbon article, such as a carbon brake disc, that is coated with an anti-oxidation coating. An embodiment of the present invention further relates to a carbon anti-oxidant coating or system. An embodiment of the present invention further relates to a primer coat composition. In one or more embodiments, a primer coat composition comprises orthophosphoric acid, aluminum chloride hydrated, a surfactant, industrial methylated spirits, and demineralized water.

In one or more embodiments, a carbon anti-oxidant system comprises a primer coat and a barrier coat, where the primer coat comprises orthophosphoric acid, aluminum chloride hydrated, a surfactant, industrial methylated spirits, and demineralized water and the barrier coat comprises orthophosphoric acid, aluminum chloride hydrated, a surfactant, industrial methylated spirits, demineralized water, colloidal silica, and boron nitride. In one or more embodiments, a barrier coat further comprises boron. In one or more embodiments, a primer coat consists of orthophosphoric acid, aluminum chloride hydrated, a surfactant, industrial methylated spirits, and demineralized water and a barrier coat consists of orthophosphoric acid, aluminum chloride hydrated, a surfactant, industrial methylated spirits, demineralized water, colloidal silica, and boron nitride. In one or more embodiments, a barrier coat further consists of boron. In one or more embodiments, a carbon brake disc is coated with a primer coat and barrier coat.

Embodiments of the present invention offer improved properties over the known art. An improved carbon anti-oxidant system and improved primer coat composition provide better protection of carbon brakes. This improved protection is accomplished by improved properties of better carbon brake surface coverage, improved thermal cycling properties, and more effective glazing and re-sealing at elevated temperatures.

The primer coat composition, carbon anti-oxidant coating, and carbon brakes that are coated with the primer coat composition and the anti-oxidant coating, will now be described in greater detail. It should be noted that the specific materials and the specific process conditions disclosed in the following disclosures are given only as examples within the scope of the invention, and this invention should not be limited to these materials or process conditions as such.

In one or more embodiments, a primer coat composition is provided. In one or more embodiments, a carbon anti-oxidant system comprises two coating layers. In one or more embodiments, a carbon anti-oxidant system comprises a primer coat and a barrier coat. A primer coat of a carbon anti-oxidant system generally functions to protect a carbon brake from catalytic oxidation.

A primer coat is the first coat that is applied to a carbon brake. As such, it is desired that a primer coat is able to infiltrate the pores of a carbon brake in order to better protect the pores against oxidation. A primer coat is able to block or partially block the pores of the carbon brake, which mitigates the effects of catalytic oxidation. In one or more embodiments, a carbon anti-oxidant system comprises a primer coat having active ingredients that react to form a product, where the reaction product blocks, or partially blocks, the pores of a carbon brake disc.

In one or more embodiments, a carbon anti-oxidant system comprises a primer coat that comprises orthophosphoric acid (also known as phosphoric acid) and aluminum chloride hydrated. The aluminum chloride hydrated can be represented by AlCl₃.6H₂0. The overall reaction between the orthophosphoric acid and aluminum chloride hydrated, which forms aluminum phosphate and hydrochloric acid, is the reaction:

AlCl₃+H₃(PO₄) [symbol] Al(PO₄)+3HCl

The objective of a primer coat is to form the aluminum phosphate from the solution during drying and curing, rather than by a precipitation reaction during mixing or application of the solution. Forming the aluminum phosphate during drying and curing results in the aluminum phosphate being cured in the carbon brake's exposed surfaces and open pores. This results in the surfaces and pores being blocked or partially blocked, which thereby mitigates the effects of oxidation, particularly catalytic oxidation. Blocking the surfaces and pores results in the catalyst particles being unable to enter the carbon brake's surfaces and pores.

In addition to achieving this reaction, it is theorized that embodiments having excess orthophosphoric acid provide additional protection against oxidation. It is believed that excess orthophosphoric acid will form phosphate glass. The phosphate glass then acts as a barrier and protects, or neutralizes, the carbon brake from catalytic oxidation, specifically protecting against catalysts used as runway deicers such as potassium acetates, potassium formates, sodium acetates, and sodium formates.

In one or more embodiments, a primer coat comprises 5 wt. % or more orthophosphoric acid, in other embodiments, a primer coat comprises 10 wt. % or more orthophosphoric acid, in yet other embodiments, a primer coat comprises 15 wt. % or more orthophosphoric acid, and in still other embodiments, a primer coat comprises 25 wt. % or more orthophosphoric acid, based upon the total weight of the primer coat.

In one or more embodiments, a primer coat comprises 70 wt. % or less orthophosphoric acid, in other embodiments, a primer coat comprises 60 wt. % or less orthophosphoric acid, in yet other embodiments, a primer coat comprises 55 wt. % or less orthophosphoric acid, and in still other embodiments, a primer coat comprises 45 wt. % or less orthophosphoric acid, based upon the total weight of the primer coat.

In one or more embodiments, a primer coat comprises 5 wt. % or more to 70 wt. % or less orthophosphoric acid, in other embodiments, a primer coat comprises 10 wt. % or more to 60 wt. % or less orthophosphoric acid, in yet other embodiments, a primer coat comprises 15 wt. % or more to 55 wt. % or less orthophosphoric acid, and in still other embodiments, a primer coat comprises 25 wt. % or more to 45 wt. % or less orthophosphoric acid, based upon the total weight of the primer coat.

In one or more embodiments, a primer coat comprises 1 wt. % or more aluminum chloride hydrated, in other embodiments, a primer coat comprises 5 wt. % or more aluminum chloride hydrated, in yet other embodiments, a primer coat comprises 10 wt. % or more aluminum chloride hydrated, and in still other embodiments, a primer coat comprises 15 wt. % or more aluminum chloride hydrated, based upon the total weight of the primer coat.

In one or more embodiments, a primer coat comprises 50 wt. % or less aluminum chloride hydrated, in other embodiments, a primer coat comprises 40 wt. % or less aluminum chloride hydrated, in yet other embodiments, a primer coat comprises 35 wt. % or less aluminum chloride hydrated, and in still other embodiments, a primer coat comprises 30 wt. % or less aluminum chloride hydrated, based upon the total weight of the primer coat.

In one or more embodiments, a primer coat comprises 1 wt. % or more to 50 wt. % or less aluminum chloride hydrated, in other embodiments, a primer coat comprises 5 wt. % or more to 40 wt. % or less aluminum chloride hydrated, in yet other embodiments, a primer coat comprises 10 wt. % or more to 35 wt. % or less aluminum chloride hydrated, and in still other embodiments, a primer coat comprises 15 wt. % or more to 30 wt. % or less aluminum chloride hydrated, based upon the total weight of the primer coat.

In one or more embodiments, a carbon anti-oxidant system comprises a primer coat that comprises a surfactant. In one or more embodiments, the surfactant is Triton X.

Triton X is a group of nonionic surfactants prepared by the reaction of octylphenol with ethylene oxide. The products of this reaction have the general chemical structure of

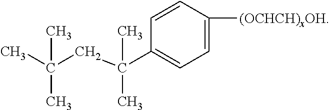

The surfactant acts as an organic wetting additive. The surfactant increases the ability of the primer to wet the carbon surface, including the open pores.

In one or more embodiments, a primer coat comprises 0.01 wt. % or more surfactant, in other embodiments, a primer coat comprises 1 wt. % or more surfactant, in yet other embodiments, a primer coat comprises 2 wt. % or more surfactant, and in still other embodiments, a primer coat comprises 3 wt. % or more surfactant, based upon the total weight of the primer coat.

In one or more embodiments, a primer coat comprises 20 wt. % or less surfactant, in other embodiments, a primer coat comprises 10 wt. % or less surfactant, in yet other embodiments, a primer coat comprises 5 wt. % or less surfactant, and in still other embodiments, a primer coat comprises 0.1 wt. % or less surfactant, based upon the total weight of the primer coat.

In one or more embodiments, a primer coat comprises 0.01 wt. % or more to 20 wt. % or less surfactant, in other embodiments, a primer coat comprises 1 wt. % or more to 10 wt. % or less surfactant, in yet other embodiments, a primer coat comprises 3 wt. % or more to 5 wt. % or less surfactant, and in still other embodiments, a primer coat comprises 0.01 wt. % or more to 0.1 wt. % or less surfactant, based upon the total weight of the primer coat.

In one or more embodiments, a carbon anti-oxidant system comprises a primer coat that comprises industrial methylated spirits. Industrial methylated spirits (IMS), or denatured alcohol, is essentially ethanol with an additive. The IMS interacts with the demineralized water that is present. The chemistry of this interaction is disclosed in R N Rothan, Solution-Deposited Metal Phosphate Coatings (September 1980), the contents of which are incorporated by reference. The reaction produces an intermediate complex which dissolves in methanol.

The IMS gives a primer coat a quick drying characteristic without impairing performance. Water-based systems that lack IMS tend to dry slowly. In these systems, when the temperature is raised to speed the drying, some of the active ingredients are lost and performance is impaired. Systems having IMS are quick drying without impacting the performance of the systems.

In one or more embodiments, a primer coat comprises 5 wt. % or more industrial methylated spirits, in other embodiments, a primer coat comprises 10 wt. % or more industrial methylated spirits, in yet other embodiments, a primer coat comprises 12 wt. % or more industrial methylated spirits, and in still other embodiments, a primer coat comprises 18 wt. % or more industrial methylated spirits, based upon the total weight of the primer coat.

In one or more embodiments, a primer coat comprises 40 wt. % or less industrial methylated spirits, in other embodiments, a primer coat comprises 30 wt. % or less industrial methylated spirits, in yet other embodiments, a primer coat comprises 25 wt. % or less industrial methylated spirits, and in still other embodiments, a primer coat comprises 20 wt. % or less industrial methylated spirits, based upon the total weight of the primer coat.

In one or more embodiments, a primer coat comprises 5 wt. % or more to 40 wt. % or less industrial methylated spirits, in other embodiments, a primer coat comprises 10 wt. % or more to 30 wt. % or less industrial methylated spirits, in yet other embodiments, a primer coat comprises 12 wt. % or more to 25 wt. % or less industrial methylated spirits, and in still other embodiments, a primer coat comprises 18 wt. % or more to 20 wt. % or less industrial methylated spirits, based upon the total weight of the primer coat.

In one or more embodiments, a carbon anti-oxidant system comprises a primer coat that comprises demineralised water. Demineralised water is water that has had its mineral ions removed, such as sodium, calcium, iron, copper, chloride and sulfate. Methods of making and obtaining demineralised water are generally known in the art. As mentioned above, one function of the demineralised water is to react with the IMS.

In one or more embodiments, a primer coat comprises 5 wt. % or more demineralised water, in other embodiments, a primer coat comprises 10 wt. % or more demineralised water, in yet other embodiments, a primer coat comprises 15 wt. % or more demineralised water, and in still other embodiments, a primer coat comprises 20 wt. % or more demineralised water, based upon the total weight of the primer coat.

In one or more embodiments, a primer coat comprises 40 wt. % or less demineralised water, in other embodiments, a primer coat comprises 35 wt. % or less demineralised water, in yet other embodiments, a primer coat comprises 30 wt. % or less demineralised water, and in still other embodiments, a primer coat comprises 25 wt. % or less demineralised water, based upon the total weight of the primer coat.

In one or more embodiments, a primer coat comprises 5 wt. % or more to 40 wt. % or less demineralised water, in other embodiments, a primer coat comprises 10 wt. % or more to 35 wt. % or less demineralised water, in yet other embodiments, a primer coat comprises 15 wt. % or more to 30 wt. % or less demineralised water, and in still other embodiments, a primer coat comprises 20 wt. % or more to 25 wt. % or less demineralised water, based upon the total weight of the primer coat.

In one or more embodiments, after a primer coat is added to the carbon brake and is sufficiently dried, a barrier coat is added to the brake. In one or more embodiments, a barrier coat contains all of the ingredients found in a primer coat. A barrier coat generally functions to protect against both catalytic oxidation and thermal oxidation.

In one or more embodiments, a barrier coat contains all of the ingredients found in a primer coat along with additional components. In embodiments where ingredients in a primer coat are replicated, it is believed that three benefits are achieved: ensuring that the surface has sufficient primer coverage to the extent that the primer coat misses areas of the surface, providing solids to the barrier coat that are cured and act as a binder to help top coat adhesion, and improving adhesion between the primer coat and barrier coat. In one or more embodiments, a primer coat components have about 10% solids.

In one or more embodiments, a barrier coat comprises 5 wt. % or more to 70 wt. % or less of a primer coat composition, in other embodiments, a barrier coat comprises 10 wt. % or more to 60 wt. % or less of a primer coat composition, in yet other embodiments, a barrier coat comprises 50 wt. % or more to 60 wt. % or less of a primer coat composition, and in still other embodiments, a barrier coat comprises 25 wt. % or more to 50 wt. % or less of a primer coat composition, based upon the total weight of the barrier coat.

In one or more embodiments, a carbon anti-oxidant system comprises a barrier coat that comprises orthophosphoric acid (also known as phosphoric acid) and aluminum chloride hydrated. The properties of the orthophosphoric acid and aluminum chloride hydrated in a barrier coat are as described above, other than the amount present.

In one or more embodiments, a barrier coat comprises 5 wt. % or more orthophosphoric acid, in other embodiments, a barrier coat comprises 8 wt. % or more orthophosphoric acid, in yet other embodiments, a barrier coat comprises 20 wt. % or more orthophosphoric acid, and in still other embodiments, a barrier coat comprises 25 wt. % or more orthophosphoric acid, based upon the total weight of the barrier coat.

In one or more embodiments, a barrier coat comprises 70 wt. % or less orthophosphoric acid, in other embodiments, a barrier coat comprises 60 wt. % or less orthophosphoric acid, in yet other embodiments, a barrier coat comprises 55 wt. % or less orthophosphoric acid, and in still other embodiments, a barrier coat comprises 35 wt. % or less orthophosphoric acid, based upon the total weight of the barrier coat.

In one or more embodiments, a barrier coat comprises 5 wt. % or more to 70 wt. % or less orthophosphoric acid, in other embodiments, a barrier coat comprises 8 wt. % or more to 60 wt. % or less orthophosphoric acid, in yet other embodiments, a barrier coat comprises 20 wt. % or more to 55 wt. % or less orthophosphoric acid, and in still other embodiments, a barrier coat comprises 25 wt. % or more to 35 wt. % or less orthophosphoric acid, based upon the total weight of the barrier coat.

In one or more embodiments, a barrier coat comprises 1 wt. % or more aluminum chloride hydrated, in other embodiments, a barrier coat comprises 5 wt. % or more aluminum chloride hydrated, in yet other embodiments, a barrier coat comprises 8 wt. % or more aluminum chloride hydrated, and in still other embodiments, a barrier coat comprises 15 wt. % or more aluminum chloride hydrated, based upon the total weight of the barrier coat.

In one or more embodiments, a barrier coat comprises 50 wt. % or less aluminum chloride hydrated, in other embodiments, a barrier coat comprises 40 wt. % or less aluminum chloride hydrated, in yet other embodiments, a barrier coat comprises 35 wt. % or less aluminum chloride hydrated, and in still other embodiments, a barrier coat comprises 20 wt. % or less aluminum chloride hydrated, based upon the total weight of the barrier coat.

In one or more embodiments, a barrier coat comprises 1 wt. % or more to 50 wt. % or less aluminum chloride hydrated, in other embodiments, a barrier coat comprises 5 wt. % or more to 40 wt. % or less aluminum chloride hydrated, in yet other embodiments, a barrier coat comprises 10 wt. % or more to 35 wt. % or less aluminum chloride hydrated, and in still other embodiments, a barrier coat comprises 15 wt. % or more to 20 wt. % or less aluminum chloride hydrated, based upon the total weight of the barrier coat.

In one or more embodiments, a carbon anti-oxidant system comprises a barrier coat that comprises a surfactant. The properties of the surfactant in a barrier coat are as described above, other than the amount present.

In one or more embodiments, a barrier coat comprises 0.01 wt. % or more surfactant, in other embodiments, a barrier coat comprises 1 wt. % or more surfactant, in yet other embodiments, a barrier coat comprises 2 wt. % or more surfactant, and in still other embodiments, a barrier coat comprises 3 wt. % or more surfactant, based upon the total weight of the barrier coat.

In one or more embodiments, a barrier coat comprises 20 wt. % or less surfactant, in other embodiments, a barrier coat comprises 10 wt. % or less surfactant, in yet other embodiments, a barrier coat comprises 5 wt. % or less surfactant, and in still other embodiments, a barrier coat comprises 0.1 wt. % or less surfactant, based upon the total weight of the barrier coat.

In one or more embodiments, a barrier coat comprises 0.01 wt. % or more to 20 wt. % or less surfactant, in other embodiments, a barrier coat comprises 1 wt. % or more to 10 wt. % or less surfactant, in yet other embodiments, a barrier coat comprises 2 wt. % or more to 5 wt. % or less surfactant, and in still other embodiments, a barrier coat comprises 0.01 wt. % or more to 0.1 wt. % or less surfactant, based upon the total weight of the barrier coat.

In one or more embodiments, a carbon anti-oxidant system comprises a barrier coat that comprises industrial methylated spirits. The properties of the industrial methylated spirits in a barrier coat are as described above, other than the amount present.

In one or more embodiments, a barrier coat comprises 5 wt. % or more industrial methylated spirits, in other embodiments, a barrier coat comprises 10 wt. % or more industrial methylated spirits, in yet other embodiments, a barrier coat comprises 15 wt. % or more industrial methylated spirits, and in still other embodiments, a barrier coat comprises 18 wt. % or more industrial methylated spirits, based upon the total weight of the barrier coat.

In one or more embodiments, a barrier coat comprises 40 wt. % or less industrial methylated spirits, in other embodiments, a barrier coat comprises 30 wt. % or less industrial methylated spirits, in yet other embodiments, a barrier coat comprises 25 wt. % or less industrial methylated spirits, and in still other embodiments, a barrier coat comprises 20 wt. % or less industrial methylated spirits, based upon the total weight of the barrier coat.

In one or more embodiments, a barrier coat comprises 5 wt. % or more to 40 wt. % or less industrial methylated spirits, in other embodiments, a barrier coat comprises 10 wt. % or more to 30 wt. % or less industrial methylated spirits, in yet other embodiments, a barrier coat comprises 15 wt. % or more to 25 wt. % or less industrial methylated spirits, and in still other embodiments, a barrier coat comprises 18 wt. % or more to 20 wt. % or less industrial methylated spirits, based upon the total weight of the barrier coat.

In one or more embodiments, a carbon anti-oxidant system comprises a barrier coat that comprises demineralised water. The properties of the demineralized water in a barrier coat are as described above, other than the amount present.

In one or more embodiments, a barrier coat comprises 5 wt. % or more demineralised water, in other embodiments, a barrier coat comprises 8 wt. % or more demineralised water, in yet other embodiments, a barrier coat comprises 15 wt. % or more demineralised water, and in still other embodiments, a barrier coat comprises 20 wt. % or more demineralised water, based upon the total weight of the barrier coat.

In one or more embodiments, a barrier coat comprises 40 wt. % or less demineralised water, in other embodiments, a barrier coat comprises 35 wt. % or less demineralised water, in yet other embodiments, a barrier coat comprises 30 wt. % or less demineralised water, and in still other embodiments, a barrier coat comprises 23 wt. % or less demineralised water, based upon the total weight of the barrier coat.

In one or more embodiments, a barrier coat comprises 5 wt. % or more to 40 wt. % or less demineralised water, in other embodiments, a barrier coat comprises 8 wt. % or more to 35 wt. % or less demineralised water, in yet other embodiments, a barrier coat comprises 15 wt. % or more to 30 wt. % or less demineralised water, and in still other embodiments, a barrier coat comprises 20 wt. % or more to 23 wt. % or less demineralised water, based upon the total weight of the barrier coat.

In one or more embodiments, a carbon anti-oxidant system comprises a barrier coat that comprises colloidal silica. Colloidal silica is a glass that acts as a binder to provide adhesion for a barrier coat, as well as adhesion between a primer coat and barrier coat. Silica glass generally forms at a higher temperature than boron glass. Boron silicate glass generally forms at a temperature in between silica glass and boron glass.

Colloidal silica also has the ability to glaze and reseal at elevated temperatures. This glazing and resealing is particularly relevant as a carbon heat sink is subjected to thermal cycling. The colloidal silica can exist as layers, which offers further protection for a carbon brake surface upon glazing and resealing. Colloidal silica also allows for the viscosity to be controlled.

The particles of colloidal silica are generally very fine. In one or more embodiments, the colloidal silica has an average particle size of from 10 nm or more to 100 nm or less. This fineness allows the particles to fill the pores of a carbon brake surface based on sufficient dispersion properties. One example of a suitable colloidal silica is LEVASIL® 200N.

In one or more embodiments, a barrier coat comprises 2 wt. % or more colloidal silica, in other embodiments, a barrier coat comprises 5 wt. % or more colloidal silica, in yet other embodiments, a barrier coat comprises 10 wt. % or more colloidal silica, and in still other embodiments, a barrier coat comprises 15 wt. % or more colloidal silica, based upon the total weight of the barrier coat.

In one or more embodiments, a barrier coat comprises 35 wt. % or less colloidal silica, in other embodiments, a barrier coat comprises 30 wt. % or less colloidal silica, in yet other embodiments, a barrier coat comprises 25 wt. % or less colloidal silica, and in still other embodiments, a barrier coat comprises 20 wt. % or less colloidal silica, based upon the total weight of the barrier coat.

In one or more embodiments, a barrier coat comprises 2 wt. % or more to 35 wt. % or less colloidal silica, in other embodiments, a barrier coat comprises 5 wt. % or more to 30 wt. % or less colloidal silica, in yet other embodiments, a barrier coat comprises 10 wt. % or more to 25 wt. % or less colloidal silica, and in still other embodiments, a barrier coat comprises 15 wt. % or more to 20 wt. % or less colloidal silica, based upon the total weight of the barrier coat.

In one or more embodiments, a carbon anti-oxidant system comprises a barrier coat that comprises boron nitride. Boron nitride is a high temperature ceramic that by itself has good resistance to oxidation up to about 900 degrees Celsius. Boron nitride is included because of its high inherent resistance to oxidation. Also, boron nitride powders have a flake-like morphology, which results in good coatings.

In one or more embodiments, a barrier coat comprises 0.01 wt. % or more boron nitride, in other embodiments, a barrier coat comprises 10 wt. % or more boron nitride, in yet other embodiments, a barrier coat comprises 15 wt. % or more boron nitride, and in still other embodiments, a barrier coat comprises 20 wt. % or more boron nitride, based upon the total weight of the barrier coat.

In one or more embodiments, a barrier coat comprises 40 wt. % or less boron nitride, in other embodiments, a barrier coat comprises 35 wt. % or less boron nitride, in yet other embodiments, a barrier coat comprises 30 wt. % or less boron nitride, and in still other embodiments, a barrier coat comprises 25 wt. % or less boron nitride, based upon the total weight of the barrier coat.

In one or more embodiments, a barrier coat comprises 0.01 wt. % or more to 40 wt. % or less boron nitride, in other embodiments, a barrier coat comprises 10 wt. % or more to 35 wt. % or less boron nitride, in yet other embodiments, a barrier coat comprises 15 wt. % or more to 30 wt. % or less boron nitride, and in still other embodiments, a barrier coat comprises 20 wt. % or more to 25 wt. % or less boron nitride, based upon the total weight of the barrier coat.

In one or more embodiments, a carbon anti-oxidant system comprises a barrier coat that comprises boron. In one or more embodiments, boron is in the form of elemental boron. In one or more embodiments, boron is in a crystalline form. In one or more embodiments, boron is in an amorphous form. As used herein, it should be appreciated that the term boron is defined as consisting substantially of boron. It should be appreciated that certain forms of boron can include small amounts of other elements, such as carbon.

The boron reacts with available oxygen to form glass. The glass then has the ability to glaze and reseal at elevated temperatures as described above. This glazing and resealing offers further protection when the carbon heat sink is subjected to thermal cycling. In combining with some of the available oxygen, the boron further protects the carbon brake by preventing this oxygen from reacting with the carbon in the brake.

In one or more embodiments, a barrier coat comprises 0.01 wt. % or more boron, in other embodiments, a barrier coat comprises 10 wt. % or more boron, in yet other embodiments, a barrier coat comprises 15 wt. % or more boron, and in still other embodiments, a barrier coat comprises 20 wt. % or more boron, based upon the total weight of the barrier coat.

In one or more embodiments, a barrier coat comprises 40 wt. % or less boron, in other embodiments, a barrier coat comprises 35 wt. % or less boron, in yet other embodiments, a barrier coat comprises 30 wt. % or less boron, and in still other embodiments, a barrier coat comprises 25 wt. % or less boron, based upon the total weight of the barrier coat.

In one or more embodiments, a barrier coat comprises 0.01 wt. % or more to 40 wt. % or less boron, in other embodiments, a barrier coat comprises 10 wt. % or more to 35 wt. % or less boron, in yet other embodiments, a barrier coat comprises 15 wt. % or more to 30 wt. % or less boron, and in still other embodiments, a barrier coat comprises 20 wt. % or more to 25 wt. % or less boron, based upon the total weight of the barrier coat.

In one or more embodiments, a carbon article is formed as a brake disc and the brake disc is coated with an anti-oxidant coating. In one or more embodiments, the anti-oxidant coating comprises a composition comprising the products of curing a primer coat and a barrier coat.

In one or more embodiments, the anti-oxidant coating comprises 5 wt. % or more to 35 wt. % or less aluminum phosphate, in other embodiments, the anti-oxidant coating comprises 10 wt. % or more to 30 wt. % or less aluminum phosphate, in yet other embodiments, the anti-oxidant coating comprises 15 wt. % or more to 25 wt. % or less aluminum phosphate, and in still other embodiments, the anti-oxidant coating comprises 18 wt. % or more to 23 wt. % or less aluminum phosphate, based upon the total weight of the anti-oxidant coating. These percentages are based on the applied (i.e. wet or uncured) primer coat.

In light of the foregoing, it should be appreciated that the present invention advances the art. An aspect of the present invention improves the art by providing an improved anti-oxidant system and improved primer coat composition protective of potassium and sodium based deicers. Another aspect of the present invention provides carbon articles, such as brake discs, that are coated with an improved anti-oxidant coating. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

Control: The starting point for comparison was a baseline anti-oxidant system. These baseline samples were coated, cured, dipped (for 30 minutes in a 25 w/w potassium acetate solution), and dried. The samples were then oxidation tested in still air at 550° C. for 8 hours and recorded an average weight loss of 15%.

Primer Coat 1 (DJ010): In one example, 174 g of hydrated aluminium chloride was placed in graduated beaker. In a separate beaker, 158 g of industrial methylated spirits, 200 g of demineralised water, and 0.22 g of Triton X-100 were combined. 151 g of orthophosphoric acid was placed in a third beaker. Then, sufficient IMS/water solution was added to dissolve the aluminium chloride while stirring by hand (or mechanically). Then, the orthophosphoric acid was added. Cuboid carbon/carbon samples were given two coats of the resultant combination, by brush. The samples were then cured using a standard thermal cycle and dipped for 30 minutes in a 25 w/w potassium acetate solution. The samples were then dried. The samples were oxidation tested in still air at 550° C. for 24 hours and recorded an average weight loss of 5.3%.

Primer Coat 2 (Primer DJ011): In another example, 174 g of hydrated aluminium chloride was placed in graduated beaker. In a separate beaker, 158 g of industrial methylated spirits, 200 g of demineralised water, and 0.22 g of Triton X-100 were combined. 288 g of orthophosphoric acid was placed in a third beaker. Then, sufficient IMS/water solution was added to dissolve the aluminium chloride while stirring by hand (or mechanically). Then, the orthophosphoric acid was added. Cuboid carbon/carbon samples were given two coats of the resultant combination, by brush. The samples were then cured using a standard thermal cycle and dipped for 30 minutes in a 25 w/w potassium acetate solution. The samples were then dried. The samples were oxidation tested in still air at 550° C. for 24 hours and recorded an average weight loss of 0.26%.

Primer Coat 3 (DJ013): In another example, 174 g of hydrated aluminium chloride was placed in graduated beaker. In a separate beaker, 158 g of industrial methylated spirits, 200 g of demineralised water, and 0.22 g of Triton X-100 were combined. 347 g of orthophosphoric acid was placed in a third beaker. Then, sufficient IMS/water solution was added to dissolve the aluminium chloride while stirring by hand (or mechanically). Then, the orthophosphoric acid was added. Cuboid carbon/carbon samples were given two coats of the resultant combination, by brush. The samples were then cured using a standard thermal cycle and dipped for 30 minutes in a 25 w/w potassium acetate solution. The samples were then dried. The samples were oxidation tested in still air at 550° C. for 24 hours and recorded an average weight loss of 0.29%.

Barrier Coat 1 (AS302): In another example, 17 g of Levasil 200N (30%) and 20 g of boron nitride were added to 50 g of Primer Coat 2 (DJ011). The combination was mixed using a high speed dispersion mixer (or a bead mix could be used) to achieve good dispersion. Using the resultant mixture, cuboid carbon/carbon samples were given one coat of Primer Coat 2 (DJ011), applied using a spray gun. The samples were then dried for 1 hour and cured using a standard thermal cycle. Two coats of Barrier Coat 1 (AS302) were then applied using a spray gun. The samples were then cured using a standard thermal cycle and dipped for 30 minutes in a 25 w/w potassium acetate solution. The samples were oxidation tested in still air at 550° C. for 264 hours and recorded an average weight loss of 1.66%.

Barrier Coat 2 (AS304): In another example, 20.6g of Levasil 200N (30%) and 23 g of boron were added to 73.5 g of Primer Coat 2 (DJ011). The combination was mixed using a high speed dispersion mixer (or a bead mix could be used) to achieve good dispersion. Using the resultant mixture, cuboid carbon/carbon samples were given one coat of Primer Coat 2 (DJ011), applied using a spray gun. The samples were then dried for 1 hour and cured using a standard thermal cycle. Two coats of Barrier Coat 1 (AS302) were then applied using a spray gun. The samples were cured using a standard thermal cycle and dipped for 30 minutes in a 25 w/w potassium acetate solution. The samples were oxidation tested in still air at 550° C. for 264 hours and recorded an average weight loss of 7.13%.

Various modifications and alterations that do not depart from the scope and spirit of this invention will become apparent to those skilled in the art. This invention is not to be duly limited to the illustrative embodiments set forth herein.

What is claimed is:

1. A carbon article formed as a brake disc, the brake disc being coated with an anti-oxidant coating, the anti-oxidant coating, as applied, comprising:
aluminum phosphate, wherein the aluminum phosphate is formed by reacting orthophosphoric acid with aluminum chloride hydrated;
a surfactant, industrial methylated spirits, and demineralised water; and
colloidal silica and boron nitride.

2. The carbon article of claim 1, wherein the anti-oxidant coating comprises aluminum phosphate in an amount from 5% to 25%.

3. The carbon article of claim 2, wherein the anti-oxidant coating comprises the surfactant in an amount from 0.01% to 0.1%, industrial methylated spirits in an amount from 10% to 30%, and demineralised water in an amount from 15% to 35%.

4. The carbon article of claim 3, wherein the anti-oxidant coating comprises colloidal silica in an amount from 10% to 25% and boron nitride in an amount from 0.01% to 25%.

5. The carbon article of claim 1, wherein the anti-oxidant coating further comprises boron.

6. A carbon article shaped as a brake disc, the brake disc being coated with an anti-oxidant coating obtained by:
applying as a primer coat a composition comprising orthophosphoric acid, aluminum chloride hydrated, a surfactant, industrial methylated spirits, and demineralised water;
curing the primer coat;
applying as a barrier coat a composition comprising orthophosphoric acid, aluminum chloride hydrated, a surfactant, industrial methylated spirits, demineralised water, colloidal silica, and boron nitride; and
curing the barrier coat.

7. The carbon article of claim 6, wherein the pre-cured primer coat comprises orthophosphoric acid in an amount from 15% to 45%, aluminum chloride hydrated in an amount from 15% to 35%, a surfactant in an amount from 0.01% to 0.1%, industrial methylated spirits in an amount from 12% to 30%, and demineralised water in an amount from 15% to 35%.

8. The carbon article of claim 7, wherein the pre-cured barrier coat comprises orthophosphoric acid in an amount from 8% to 30%, aluminum chloride hydrated in an amount from 8% to 20%, a surfactant in an amount from 0.01% to 0.1%, industrial methylated spirits in an amount from 5% to 20%, demineralized water in an amount from 9% to 20%, colloidal silica in an amount from 10% to 25%, and boron nitride in an amount from 5% to 25%.

9. The carbon article of claim 6, wherein the pre-cured barrier coat further comprises boron.

10. A carbon anti-oxidant system, as applied, comprising:
a primer coat composition comprising orthophosphoric acid, aluminum chloride hydrated, a surfactant, industrial methylated spirits, and demineralised water; and
a barrier coat composition comprising orthophosphoric acid, aluminum chloride hydrated, a surfactant, industrial methylated spirits, demineralised water, colloidal silica, and boron nitride.

11. The carbon anti-oxidant system of claim 10, wherein a primer coat comprises orthophosphoric acid in an amount from 15% to 45%, aluminum chloride hydrated in an amount from 15% to 35%, a surfactant in an amount from 0.01% to 0.1%, industrial methylated spirits in an amount from 12% to 30%, and demineralised water in an amount from 15% to 35%.

12. The carbon anti-oxidant system of claim 11, wherein the barrier coat comprises orthophosphoric acid in an amount from 8% to 30%, aluminum chloride hydrated in an amount from 8% to 20%, a surfactant in an amount from 0.01% to 0.1%, industrial methylated spirits in an amount from 5% to 20%, demineralized water in an amount from 9% to 20%, colloidal silica in an amount from 10% to 25%, and boron nitride in an amount from 5% to 25%.

13. The carbon anti-oxidant system of claim 10, wherein the primer coat further comprises boron.

14. A primer coat composition, comprising:
orthophosphoric acid, aluminum chloride hydrated, a surfactant, industrial methylated spirits, and demineralised water.

15. The primer coat composition of claim 14, wherein a primer coat comprises orthophosphoric acid in an amount from 15% to 45% and aluminum chloride hydrated in an amount from 15% to 35%.

16. The primer coat composition of claim 15, wherein a primer coat comprises the surfactant in an amount from 0.01% to 0.1%, industrial methylated spirits in an amount from 12% to 30%, and demineralised water in an amount from 15% to 35%.

17. The primer coat composition of claim 14, wherein the primer coat further comprises boron.
